(19) United States
(12) Patent Application Publication
(10) Pub. No.: US 2016/0243564 A1
(43) Pub. Date: Aug. 25, 2016

(54) INTERNALLY ADJUSTABLE SPRAY ANGLE ROTARY NOZZLE

(71) Applicant: STONEAGE, INC., Durango, CO (US)

(72) Inventors: Colton Andersen, Durango, CO (US); Douglas E. Wright, Durango, CO (US)

(21) Appl. No.: 15/044,402

(22) Filed: Feb. 16, 2016

Related U.S. Application Data
(60) Provisional application No. 62/119,462, filed on Feb. 23, 2015.

(51) Int. Cl. B05B 3/04; B05B 1/30

(52) U.S. Cl. CPC B05B 3/0463; B05B 1/30

(57) ABSTRACT

A rotary nozzle apparatus is disclosed which includes a cup shaped outer housing having a central axis, a wall portion and a bottom portion. A tubular inner housing is centered on the central axis within the outer housing engaging the wall portion of the outer housing. A distal end of an elongated tubular nozzle body carries a nozzle head extending through a passage out of the inner housing to an opening through the bottom portion of the outer housing. The nozzle body is configured to rotate around a conical inner wall portion of the inner housing in response to rotational fluid flow into the inner housing. The angle of the nozzle body with respect to the central axis, and hence fluid spray angle may be adjusted from a wide spray angle to an axial stream by changing spacing between the bottom portion of the outer housing and the inner housing.

### CROSS REFERENCE TO RELATED APPLICATIONS

This application claims the benefit of priority of U.S. Provisional Patent Application No. 62/119,462 filed Feb. 23, 2015, entitled Internally Adjustable Spray Angle Rotary Nozzle, the content of which is incorporated by reference herein in its entirety.

### BACKGROUND OF THE DISCLOSURE

The present disclosure is directed to high pressure fluid rotary nozzle systems. In particular, embodiments of the present disclosure are directed to an internally adjustable spray angle rotary nozzle.

Rotary nozzles provide a means of directing a concentrated high pressure stream of fluid over a relatively large surface area by directing the stream in a continuously changing direction about a central axis through the nozzle assembly. One such nozzle is described in U.S. Pat. No. 8,820,659 B2. A rotary nozzle body within a housing rotates around the interior of the housing causing the stream of fluid exiting the nozzle to cover a large area. However, the spray angles of such nozzles are not adjustable. It would be advantageous in some applications to be able to adjust the spray angle of such a high pressure nozzle apparatus without having to physically change the rotary nozzle for one with a narrower or wider spray angle.

### SUMMARY OF THE DISCLOSURE

The present disclosure directly addresses such needs. The present disclosure addresses this by providing a rotary nozzle apparatus that is infinitely adjustable from an axial stream to a wide spray angle. One exemplary embodiment of such a nozzle apparatus includes a cup shaped outer housing having a central axis, a wall portion and a bottom portion. A tubular inner housing is disposed in and centered on the central axis within the outer housing and has a feature engaging the wall portion of the outer housing. This feature may be threads, a cam, a friction strip or other mechanical linkage orienting the inner and outer housings. An elongated nozzle body is carried within the inner housing. This nozzle body has a tubular stem. A distal end of the stem carries a nozzle head that extends through an axial passage out of the inner housing and in to the bottom portion of the outer housing. The nozzle body is configured to rotate around the central axis along a conical inner wall portion of the inner housing and direct fluid through the nozzle body, out through the nozzle head, and out through an opening in the bottom portion of the outer housing. An angle of the nozzle body with respect to the central axis may be adjusted by changing an axial spacing between the bottom portion of the outer housing and the inner housing.

One embodiment of a nozzle apparatus according to the present disclosure includes an inlet nut to which is connected a high pressure fluid supply hose, such as one carrying water, under pressures that can range from 50 psi to 20,000 psi. This inlet nut is generally tubular with a substantially closed distal end. This distal end is threaded into the inner housing of the apparatus and the distal end has one or more peripheral openings that direct high pressure fluid tangentially into the interior of the inner housing. The tubular inner housing has a cylindrical inner wall portion and a conical inner wall portion that joins a passage out of the inner housing.

The nozzle body is captured between the inner housing and an inlet nut fastened to a proximal end of the inner housing. The inlet nut is configured to direct fluid out of the inlet nut tangentially to a periphery of the cylindrical wall portion so as to create a rotational flow of high fluid about the central axis and rotating around a proximal end of the nozzle body. This rotational flow of fluid is what causes the nozzle body to rotate around the conical wall portion of the inner housing.

The proximal end of the nozzle body has a plurality of axially extending vanes. These vanes extend through the proximal end to substantially reduce rotational flow of fluid passing into the nozzle body such that fluid flow into the nozzle head is substantially axial rather than rotational.

The cup shaped outer housing is preferably threaded onto and over the inner housing. A bottom portion of the outer housing has a central bore therethrough and an annular valve seat disposed in the bore. This valve seat receives the nozzle head on the nozzle stem and preferably the nozzle head is captured within the valve seat by an O-ring disposed in the valve seat.

The axial spacing between the inner housing and the outer housing is changed by changing orientation of the feature engaging inner housing with respect to the outer housing about the central axis. This feature may be the exterior of the inner housing and the interior of the outer housing having complementary features such as threads to facilitate this rotation. The stem of the nozzle body has an enlarged diameter mid portion for engaging the conical wall portion of the inner housing. The mid portion of the stem substantially closes the passage out of the inner housing so as to direct fluid spray only along the central axis when the inner housing is fully spaced from the outer housing. As the space between the outer and inner housings is reduced, the nozzle body begins to rotate in wider and wider circles due to the rotational high pressure fluid flow around the nozzle body. Therefore the widest spray path is achieved when there is no space left between the inner and outer housings.

An embodiment of a nozzle in accordance with the present disclosure may include a cylindrical cup shaped outer housing having a central axis. This outer housing has a tubular wall portion and an annular disc shaped bottom portion. A tubular inner housing is centered on the central axis within the outer housing and threadably engages the tubular wall portion of the outer housing. An elongated generally tubular nozzle body is carried within the inner housing. This nozzle body has a tubular stem. A distal end of the stem carries a generally conical nozzle head that extends through a passage out of the inner housing to the bottom portion of the outer housing. The nozzle body has a thickened mid portion and is configured to rotate around the central axis along a conical inner wall portion of the inner housing and direct fluid through the nozzle body and out through the nozzle head. The angle of the nozzle body with respect to the central axis, and hence the spray angle of ejected fluid passing through the nozzle may be adjusted simply by changing the axial spacing between the bottom portion of the outer housing and the inner housing.

Further features, advantages and characteristics of the embodiments of this disclosure will be apparent from reading the following detailed description when taken in conjunction with the drawing figures.

### DESCRIPTION OF THE DRAWINGS

FIG. 1 is a longitudinal sectional view of a nozzle apparatus in accordance with the present disclosure with the inner housing abutting against the bottom portion of the outer housing to provide a wide spray angle about the apparatus central axis.

FIG. 2 is a longitudinal sectional view of the nozzle apparatus shown in FIG. 1 with the inner housing intermediately spaced from the bottom portion of the outer housing to provide a narrower spray angle about the central axis.

FIG. 3 is a longitudinal sectional view of the nozzle apparatus shown in FIG. 1 with the inner housing fully spaced from the bottom portion of the outer housing to provide an axial fluid flow path.

FIG. 4 is a forward cross sectional view of the nozzle apparatus shown in FIG. 1 taken along the line 4-4 in FIG. 1.

FIG. 5 is forward cross sectional view of the nozzle apparatus shown in FIG. 1 taken along the line 5-5 in FIG. 1.

FIG. 6 is an exploded longitudinal sectional view of the nozzle apparatus shown in FIG. 1.

FIG. 7 is an exploded exterior view of the nozzle apparatus shown in FIG. 6.

### DETAILED DESCRIPTION

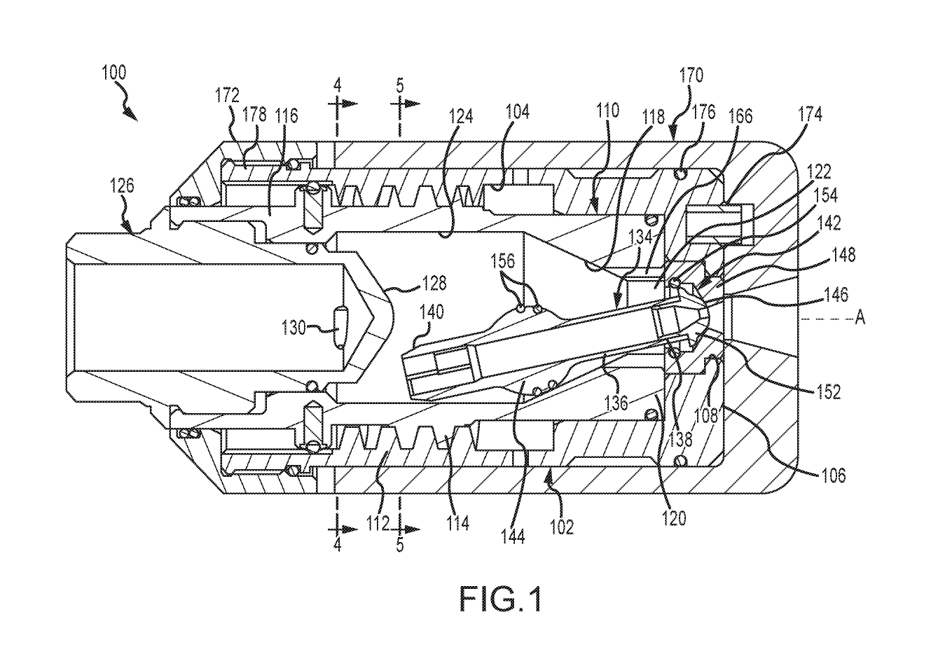

A longitudinal sectional view of a nozzle apparatus 100 in accordance with the present disclosure is shown in FIG. 1. The apparatus 100 is generally symmetrical about a central axis A through the apparatus 100. The apparatus 100 includes a cup shaped outer housing 102 having a cylindrical wall portion 104 and a generally flat radially extending bottom portion 106 extending outward to the wall portion 104 from a central opening 108.

A tubular inner housing 110 is carried within the outer housing 102 via complementary features, preferably internal ACME threads 112 on the wall portion 104 of the outer housing 102 and external ACME threads 114 on the exterior of the inner housing 110. The inner housing 110 has a proximal end portion 116, a conical inner wall portion 118 and a distal end portion 120 that has a central passage 122 therethrough. The inner housing 110 further has an inner cylindrical wall portion 124 between the proximal end portion 116 and the conical inner wall portion 118.

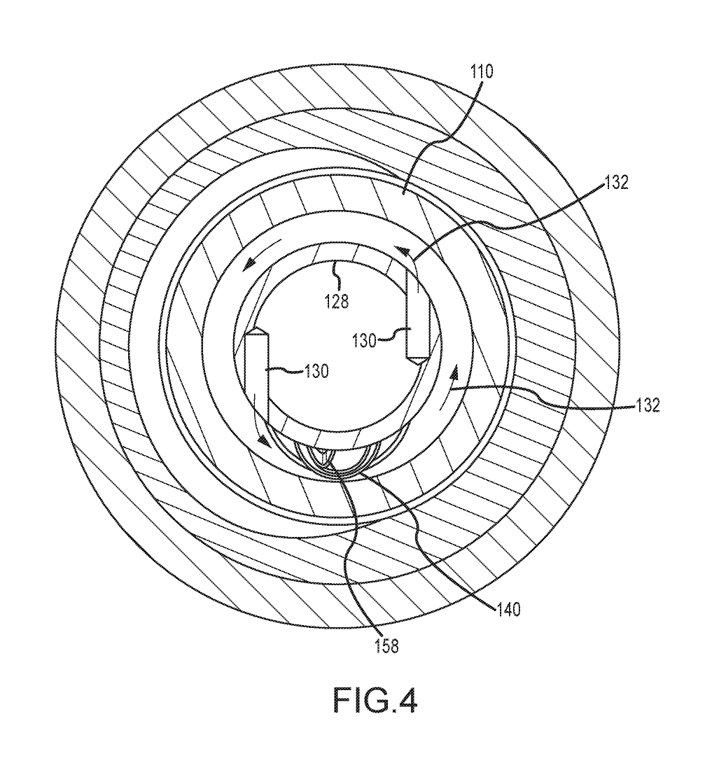

Closing the proximal end portion 116 is an inlet nut 126 that is threaded into the proximal end portion 116. The inlet nut 126 is, in turn, fastened to a high pressure fluid supply hose, not shown. The inlet nut 126 is tubular with a closed distal end 128 preferably having a conical external shape. The distal end 128 has at least a pair of peripheral tangential port bores 130 to direct fluid exiting the inlet nut 126 into the inner housing tangentially round the cylindrical wall portion 124. This method of directing fluid entry into the inner housing 110 causes the fluid to flow in a rotating direction indicated by arrows 132, shown in the sectional view of FIG. 4.

Captured within the inner housing 110 is a nozzle body 134. Nozzle body 134 includes a tubular stem 136, a distal end 138 and a proximal end 140. The distal end 138 carries a convergent nozzle head 142. The nozzle body stem 136 has an enlarged diameter mid portion 144 which, in operation, rolls the nozzle body 134 along and around the conical inner wall portion 118 of the inner housing 110 in response to the rotational fluid flow within the inner housing 110. A pair of O-rings 156 around the mid portion 144 facilitates smooth rotation of the nozzle body 134 as it rolls around the inner wall portion 118 of the inner housing 110 during operation.

The nozzle head 142 has a rounded, semispherical end portion 146 that abuts into an annular cup shaped nozzle seat 148 that is pressed into the opening 108 of the outer housing 102. The head 142 has a tubular sleeve portion 150 and a flange 152 between the semispherical end portion 146 and the sleeve portion 150. The nozzle seat 148 has an annular recess carrying an O-ring 154. The flange 152 of the head 142 engages the O-ring 154 to prevent removal of the head 142 from the seat 148. The sleeve portion 138 of the nozzle head 142 is press fit into the distal end 138 of the stem 136.

Inside the stem 136 at its proximal end 140 is an axial vane structure 158. This vane structure 158, typically made of sheet metal, is designed to straighten the rotational fluid flow present in the inner housing 110 into axial fluid flow as the high pressure fluid passes into and through the nozzle body 134.

FIGS. 1-3 illustrate how the flow through the nozzle apparatus 100 is manually adjusted by an operator. FIG. 1 shows the inner housing 110 butted up against the bottom portion 106 of the outer housing 102. When high pressure fluid is applied to the inlet nut 126, fluid flows through the ports 130 tangentially into the cylindrical wall portion of the inner housing 110 setting up a strong rotational flow of fluid. This position between the inner and outer housings permits the nozzle body 134 to rotate around the large diameter end of the conical inner surface 118 of the inner housing 110. Thus a large angle between the nozzle body and the central axis A is generated and a wide arc of high pressure fluid flow stream results coming out of the nozzle head 142.

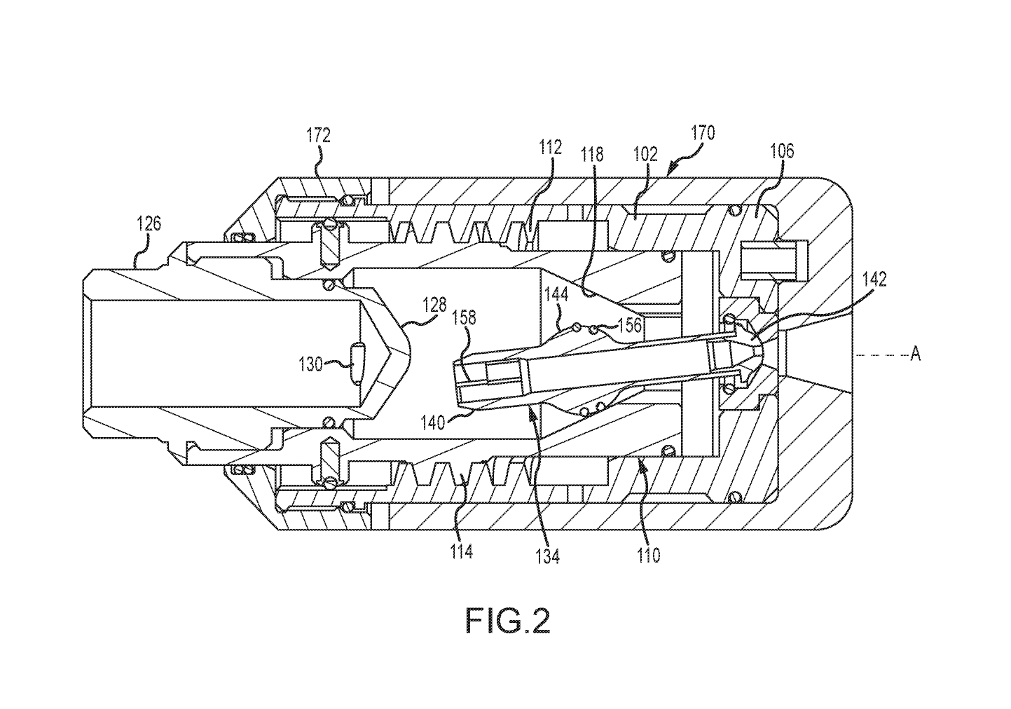

FIG. 2 shows the same nozzle apparatus 100 with the inner and outer housings 110 and 102 rotated relative to each other such that the inner housing 110 is spaced part way from the bottom portion 106 of the outer housing 102. The nozzle body 134 still remains with the nozzle head 142 abutted against the nozzle seat 148. However, the mid portion 144 of the nozzle body 134 now rotates around a narrower diameter portion of the conical wall portion 118 of the inner housing 110. Hence the arc generated by the fluid flowing through the nozzle head 142 is much narrower than that shown in FIG. 1.

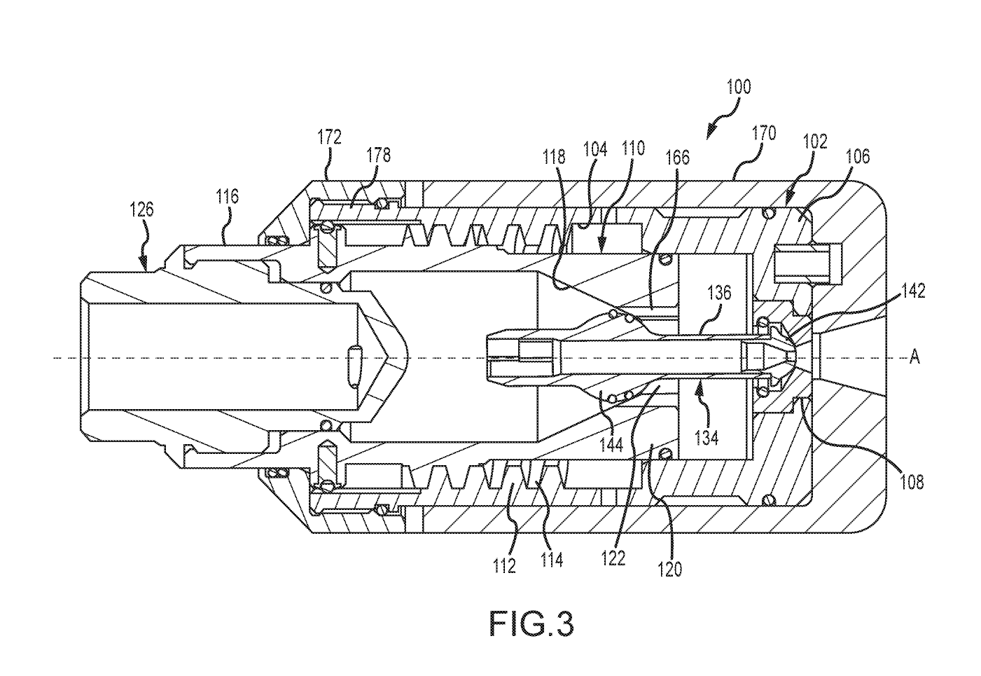

FIG. 3 shows the nozzle apparatus 100 in a fully withdrawn configuration where the nozzle body 134 is fully aligned with axis A and the mid portion 144 no longer rotates about the conical wall portion 118 of the inner housing 110. In this position, the mid portion 144 of the nozzle body stem 136 essentially plugs the passage 122 out of the inner housing 110 except for a bypass passage 166. This bypass passage 166 ensures pressure equalization between the interior of the inner housing 110 and the space between the inner and outer housings 110 and 102.

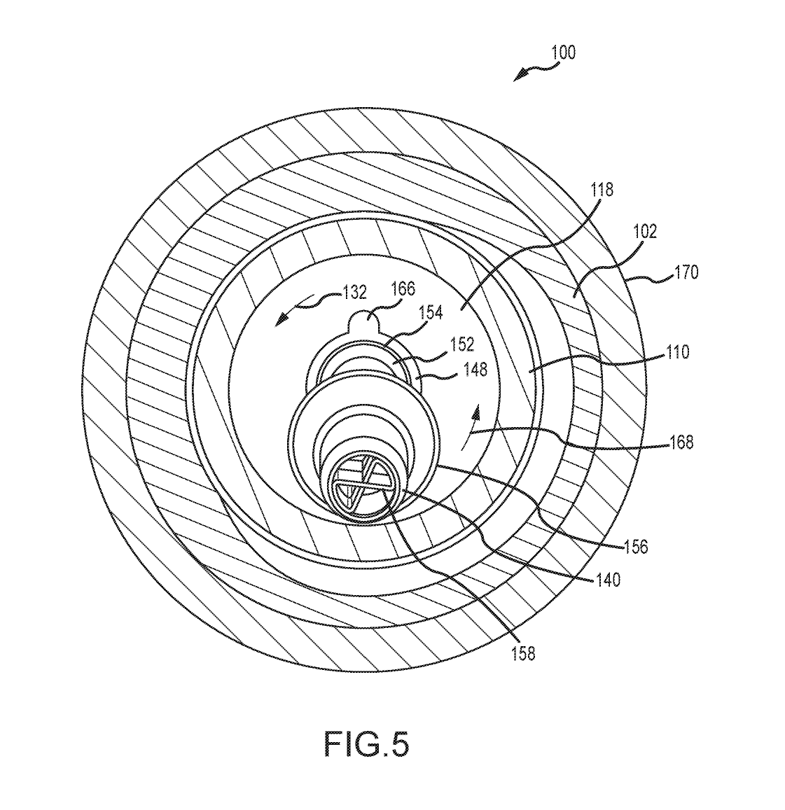

Cross sectional views through the apparatus 100 are shown in FIGS. 4 and 5. FIG. 4 shows the layout of the tangential ports 130 out of the inlet nut 126 into the interior of the inner housing 110 along with directional arrows 132 depicting fluid flow direction within the housing 110 around the inlet end 140 of the nozzle body 134. FIG. 5 shows the equalization passage 166 along with the nozzle body 134 and direction arrows 168 indicating the direction of rotation of the nozzle body 134 around the conical surface 118 of the inner housing 110.

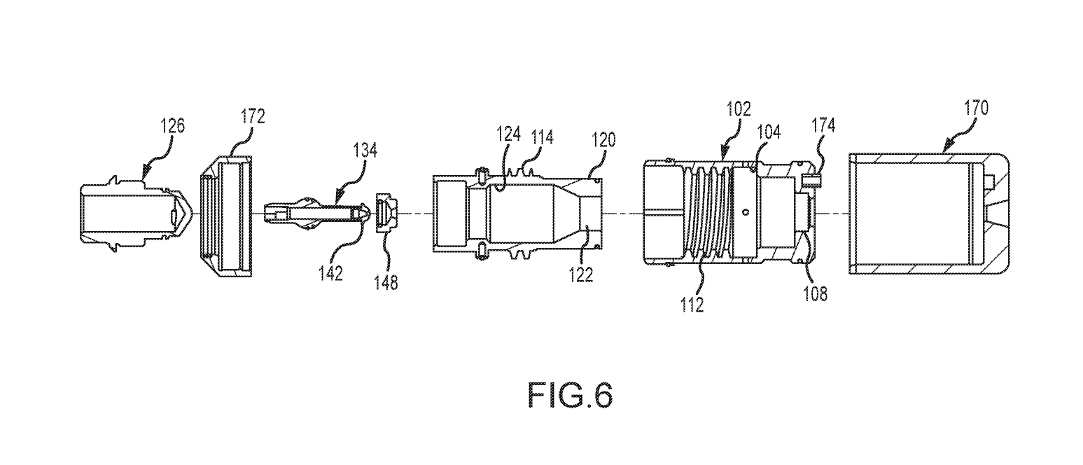

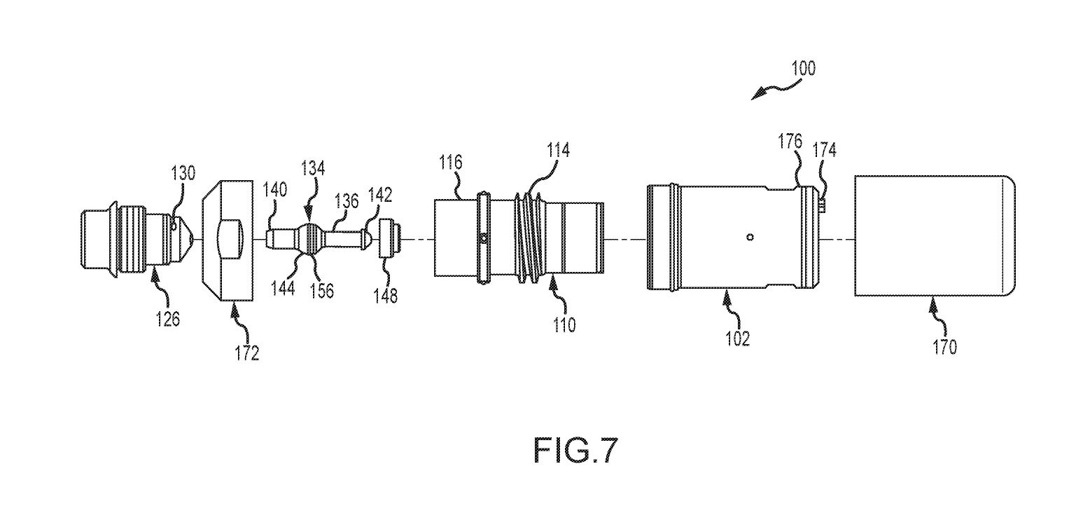

FIGS. 6 and 7 show exploded views both sectional and external of the component parts already discussed. Also shown in FIGS. 1-7 is a cup shaped external shroud 170 that is preferably installed over the outer housing 102 and a mating collar 172 that together surround the inner and outer housings. The collar 172 is threaded onto the proximal end 178 of the outer housing 102 and shroud 170 is pinned to the outer housing 102 via a tubular pin 174 to ensure that the housing 102 rotates with the shroud 170 when shroud 170 is manually turned about axis A and the inlet nut 126 to change the spacing between the housings 102 and 110 as shown in FIGS. 1-3.

Inlet nut 126 has external threads which engage internal threads in the proximal end 116 of the inner housing 110. An O-ring 176 around the base portion 106 of the outer housing 102 engages a corresponding recess in the shroud 170 to axially keep the shroud 170 on the outer housing 102. The collar 172 has internal threads which engage external threads on the proximal end 178 of the outer housing 102.

Referring now to FIGS. 6 and 7, assembly of the nozzle apparatus 100 is explained. First the seat 148 is pressed into the opening 108 through the bottom portion 106 of the outer housing 102 and the O-ring 154 installed in the seat 148. Next, the inner housing 110 is fully inserted into the outer housing 102 to the position shown in FIG. 1. The nozzle body 134 is then installed with the nozzle head 142 pressed past the O-ring 154 such that the flange 152 retains the nozzle head 142 within the seat 148. The inlet nut 126 is then threaded into the proximal end of the inner housing 110. Finally, the collar 172 is threaded onto the proximal end 178 of the outer housing 102 and the shroud 170 snapped in place over the outer housing 102 and rotated such that the pin 174 engages a corresponding recess in the base of the shroud 170.

A number of changes may be made to the nozzle apparatus in accordance with the present disclosure. For example, the passage 166 may be eliminated in certain applications. The mid portion 144 of the stem 146 may be a separate sleeve fastened around the stem 146 so as to form the external spherical ball shape shown. The vane structure 158 may be formed otherwise than specifically shown. For example, the sheet metal vane structure 158 as seen in FIG. 5 may have a triangular or star shape rather than a FIG. 8 cruciform shape as shown. The entire valve body 134 may be constructed out of one piece of tubular material. The conical wall 118 may extend further along the interior of the inner housing 110 and at a different angle from axis A than as shown in the figures. The distal end 128 of the inlet nut 126 may be tapered as is shown or untapered or may have a different cross sectional shape than as shown. The distal end of the inlet nut 126 may be shaped in a more elongated cone and the proximal end of the valve body 134 shaped in a complementary divergent cone to enhance the swirl of incoming fluid around the cylindrical portion of the inner housing 110 in direction 132. The engaging feature between the inner and outer housings 110 and 102 may be a friction strip or a slot and key configuration. Alternatively different threads 112 and 114 other than ACME threads may be utilized in the mating of inner and outer housings 110 and 102. For example, a rotary cam linkage or other mechanical linkage configuration may be utilized in place of ACME threads to change the spacing between the inner housing 110 and outer housing 102. Finally, a different number of O-rings may be utilized throughout than as particularly shown, and the shroud 170 may be eliminated in some alternative designs without departing from the essence of the present disclosure.

All such changes, alternatives and equivalents in accordance with the features and benefits described herein, are within the scope of the present disclosure. Such changes and alternatives may be introduced without departing from the spirit and broad scope of my invention as defined by the claims below and their equivalents.

What is claimed is:

1. A rotary nozzle apparatus comprising:
a cup shaped outer housing having a central axis, the outer housing having a wall portion and a bottom portion;
a tubular inner housing centered on the central axis within the outer housing having a feature engaging the wall portion of the outer housing; and
an elongated nozzle body carried within the inner housing, the nozzle body having a tubular stem, a distal end of the stem carrying a nozzle head extending through a passage out of the inner housing to the bottom portion of the outer housing, wherein the nozzle body is configured to rotate around the central axis along a conical inner wall portion of the inner housing and direct fluid through the nozzle body and out through the nozzle head, and wherein an angle of the nozzle body with respect to the central axis may be adjusted by changing orientation of the feature engaging the wall portion of the outer housing to change an axial spacing between the bottom portion of the outer housing and the inner housing.

2. The apparatus of claim 1 wherein the feature of the inner housing includes ACME threads engaging complementary ACME threads on the wall portion of the outer housing.

3. The apparatus of claim 1 wherein the nozzle head is captured within the bottom portion of the outer housing.

4. The apparatus of claim 1 further comprising an inlet nut fastened to an inlet portion of the inner housing, wherein the inner housing has a cylindrical wall portion between the inlet portion and the conical inner wall portion, and wherein the inlet nut is configured to direct fluid out of the inlet nut tangentially to a periphery of the cylindrical wall portion so as to create a rotational flow of fluid about the central axis rotating around a proximal end of the nozzle body.

5. The apparatus according to claim 4 wherein the proximal end of the nozzle body has a plurality of axially extending vanes therein to substantially reduce rotational flow of fluid passing into the nozzle body.

6. The apparatus according to claim 1 wherein the bottom portion of the outer housing has a central bore and an annular valve seat disposed in the bore, the valve seat receiving the nozzle head.

7. The apparatus according to claim 6 further comprising an O-ring disposed in the valve seat capturing the nozzle head within the valve seat.

8. The apparatus according to claim 6 wherein axial spacing between the inner housing and the outer housing is changed by relative rotation of the inner housing with respect to the outer housing about the central axis.

9. The apparatus according to claim 1 wherein the stem of the nozzle body has an enlarged diameter mid portion for engaging the conical wall portion of the inner housing.

10. The apparatus according to claim 9 wherein the mid portion of the stem substantially closes the passage out of the inner housing to direct fluid spray only along the central axis when the inner housing is fully spaced from the outer housing.

11. A rotary nozzle apparatus comprising:
a cylindrical cup shaped outer housing having a central axis, the outer housing having a tubular wall portion and a disc shaped bottom portion;
a tubular inner housing centered on the central axis within the outer housing engaging the tubular wall portion of the outer housing; and
an elongated nozzle body carried within the inner housing, the nozzle body having a tubular stem, a distal end of the stem carrying a nozzle head extending through a passage out of the inner housing to the bottom portion of the outer housing, wherein the nozzle body is configured to rotate around the central axis along a conical inner wall portion of the inner housing and direct fluid through the nozzle body and out through the nozzle head, and wherein an angle of the nozzle body with respect to the central axis may be adjusted by rotatably changing an axial spacing between the bottom portion of the outer housing and the inner housing.

12. The apparatus of claim 11 wherein the inner housing has external ACME threads engaging complementary internal ACME threads on the wall portion of the outer housing.

13. The apparatus of claim 11 wherein the nozzle head is captured within the bottom portion of the outer housing.

14. The apparatus of claim 11 further comprising an inlet nut fastened to an inlet portion of the inner housing, wherein the inner housing has a cylindrical wall portion between the inlet portion and the conical inner wall portion, and wherein the inlet nut is configured to direct fluid out of the inlet nut tangentially to a periphery of the cylindrical wall portion so as to create a rotational flow of fluid about the central axis rotating around a proximal end of the nozzle body.

15. The apparatus according to claim 14 wherein the proximal end of the nozzle body has a plurality of axially extending vanes therein to substantially reduce rotational flow of fluid passing into the nozzle body.

16. The apparatus according to claim 11 wherein the bottom portion of the outer housing has a central bore and an annular valve seat disposed in the bore, the valve seat receiving the nozzle head.

17. The apparatus according to claim 16 further comprising an O-ring disposed in the valve seat capturing the nozzle head within the valve seat.

18. The apparatus according to claim 16 wherein axial spacing between the inner housing and the outer housing is changed by relative rotation of the inner housing with respect to the outer housing about the central axis.

19. The apparatus according to claim 11 wherein the stem of the nozzle body has an enlarged diameter mid portion for engaging the conical wall portion of the inner housing.

20. The apparatus according to claim 19 wherein the mid portion of the stem substantially closes the passage out of the inner housing to direct fluid spray only along the central axis when the inner housing is fully spaced from the outer housing.
